(19) United States
(12) Patent Application Publication
(10) Pub. No.: US 2026/0188061 A1
(43) Pub. Date: Jul. 2, 2026

(54) METHOD, SYSTEM AND COMPUTER READABLE STORAGE MEDIUM FOR IMPLEMENTING VEHICLE LANE CHANGE PREDICTION

(71) Applicant: MiTAC Digital Technology Corporation, Taoyuan City (TW)

(72) Inventor: Hsiang-Yu HSIEH, Taoyuan City (TW)

(21) Appl. No.: 19/425,137

(22) Filed: Dec. 18, 2025

(30) Foreign Application Priority Data
Jan. 2, 2025 (TW) 114100162
Jun. 25, 2025 (TW) 114123874

(51) Int. Cl. G07C 5/04; B60Q 9/00

(52) U.S. Cl. CPC G07C 5/04; B60Q 9/00

(57) ABSTRACT

A method for implementing vehicle lane change prediction for a vehicle is implemented using a system that is connected to an in-vehicle electronic device installed in the vehicle. The system includes a lane change prediction module and a lane change probability module. The method includes: while the vehicle is being driven by a driver, continuously receiving a driving state dataset from the in-vehicle electronic device; processing, by the lane change prediction module, the driving state dataset recorded during a first time period, in order to generate a prediction result that indicates an amount of lateral offset of the vehicle due to the driver making a lane change within an incoming second time period; and calculating, by the lane change probability module, a lane change probability based on the prediction result.

### CROSS-REFERENCE TO RELATED APPLICATION

This application claims priority to Taiwanese Invention Patent Application No. 114100162 filed on Jan. 2, 2025 and Taiwanese Invention Patent Application No. 114123874 filed on Jun. 25, 2025, the entire disclosure of which is incorporated by reference herein.

### FIELD

The disclosure relates to a method, a system and a computer readable storage medium for implementing vehicle lane change prediction, and more particularly to a system and a computer readable storage medium for implementing vehicle lane change prediction that employs driver behavior detection.

### BACKGROUND

In the field of vehicle digital video recorders (DVRs), a number of functions may be incorporated to provide more services to the driver, such as network connectivity (which may be implemented by using the fourth generation (4G) or the fifth generation (5G) of wireless mobile telecommunications technology) for uploading videos, using an in-vehicle camera to detect driver concentration, using a front camera for road lane marking detection, using a rear camera that serves as a blind spot information system (BSIS) for detection, etc.

One of the functions provided by the DVRs is the land departure warning system (LDWS), which is configured to use images captured by the front camera to detect whether the vehicle drifts out of the lane. Typically, the LDWS functions based on activation of turn signals. Specifically, the LDWS may determine that the vehicle is accidentally drifting out of the lane in a case where the vehicle has been approaching the lane marking, but the turn signals are not activated. In such cases, the LDWS may output an alert (e.g., a sound alert) to notify the driver.

It is noted that the vehicles are not usually sold along with the DVRs, and therefore not all DVRs are able to be connected to the turn signals. Therefore, the LDWS may not be able to function based on the turn signals, so that the detection of the LDWS may be inaccurate, which results in unnecessary false alerts, causing the drivers to ignore the alerts and/or simply deactivate the LDWS.

One of the potential solutions is to install a controller area network (CAN) bus adaptor on the vehicle to serve as an intermediate between the DVR and the turn signals, and use a cable to electrically connect the DVR to the turn signals.

Alternatively, for a vehicle with a turn signal lever, a sensor may be mounted on an end of the turn signal lever, in order to detect whether the turn signal lever has been moved by the driver. It is indicated that the driver actually intends to turn the vehicle when the sensor detects that the turn signal lever has been moved by the driver.

In addition, a driver monitoring system (DMS) is configured to processes images of the in-vehicle camera to determine whether the driver has turned his/her head, so as to determine whether the driver is concentrating. In a case where the driver has turned his/her head for longer than a threshold time period, the DMS may determine that the driver is not concentrating, and output an alert (e.g., a sound alert) to notify the driver. It is noted that due to different personal driving habits, the driver may turn his/her head for longer when reversing or turning the vehicle; as a result, the detections of the DMS may be inaccurate, which results in unnecessary false alerts as well.

It is noted that in managing vehicle fleets (trucks, buses, etc.), in a case of an alert being generated, the images processed by the LDWS and/or DMS may be uploaded to a server for record. As such, in a case where the alerts from both the LDWS and DMS are false, the associated images may be uploaded nonetheless, causing unnecessary usage of network flow.

### SUMMARY

Therefore, one object of the disclosure is to provide a method that can alleviate at least one of the drawbacks of the prior art.

According to the one embodiment of the disclosure, the method for implementing vehicle lane change prediction for a vehicle is implemented using a system that is connected to an in-vehicle electronic device installed in the vehicle. The system including a lane change prediction module and a lane change probability module. The method includes:
training a lane change prediction model using a first driving state dataset and a second driving state dataset, wherein the first driving state dataset includes a plurality of subsets of first driving state data that indicate the driver is found to be in a distracted state and is not attempting to change lanes, and the second driving state dataset includes a plurality of subsets of second driving state data that indicate the driver is attempting to change lanes;
a) while the vehicle is being driven by a driver, continuously receiving a driving state dataset from the in-vehicle electronic device;
b) processing, by the lane change prediction module, the driving state dataset recorded associated with a first time period, in order to generate a prediction result that indicates an amount of lateral offset of the vehicle due to the driver making a lane change within an incoming second time period; and
c) calculating, by the lane change probability module, a lane change probability based on the prediction result.

Another object of the disclosure is to provide a prediction system that is configured to implement the above-mentioned method.

According to the one embodiment of the disclosure, the prediction system for implementing vehicle lane change prediction for a vehicle is connected to an in-vehicle electronic device installed in the vehicle and includes a lane change prediction module and a lane change probability module. Specifically:
the lane change prediction module includes a lane change prediction model pre-trained using a first driving state dataset and a second driving state dataset, wherein the first driving state dataset includes a plurality of subsets of first driving state data that indicate the driver is found to be in a distracted state and is not attempting to change lanes, and the second driving state dataset includes a plurality of subsets of second driving state data that indicate the driver is attempting to change lanes;
while the vehicle is being driven by a driver, the prediction system continuously receives a driving state dataset from the in-vehicle electronic device;

in response to receipt of the driving state dataset, the lane change prediction module processes the driving state dataset recorded associated with a first time period, and to generate a prediction result that indicates an amount of lateral offset of the vehicle due to the driver making a lane change within an incoming second time period; and
the lane change probability module calculates a lane change probability based on the prediction result.

Yet another object of the disclosure is to provide a non-transitory computer readable storage medium which stores instructions that, when executed by a processor of a system connected to an in-vehicle electronic device, cause the processor to implement the steps of the method as claimed in claim 1.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a flow chart illustrating steps of a method for implementing vehicle lane change prediction according to one embodiment of the disclosure.

FIG. 2 is a block diagram illustrating a prediction system for implementing vehicle lane change prediction according to one embodiment of the disclosure.

FIG. 3 illustrates a first set of successive images, in which the driver intends to change lanes, and a second set of successive images, in which the driver is distracted and does not intend to change lanes.

FIG. 4 is a graph illustrating a test dataset that includes an offset signal, a turning angle signal and a blind spot object signal over a time period.

FIG. 5 is a graph illustrating the offset signal of the test dataset and the prediction result generated by a lane change prediction model of the system over time.

FIG. 6 is a graph illustrating the offset signal of the test dataset, the prediction result generated by the lane change prediction model and a lane change probability generated by the lane change probability module over time.

FIG. 7 is a partially enlarged view of FIG. 6.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

Throughout the disclosure, the term “coupled to” or “connected to” may refer to a direct connection among a plurality of electrical apparatus/devices/equipment via an electrically conductive material (e.g., an electrical wire), or an indirect connection between two electrical apparatus/devices/equipment via another one or more apparatus/devices/equipment, or wireless communication.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

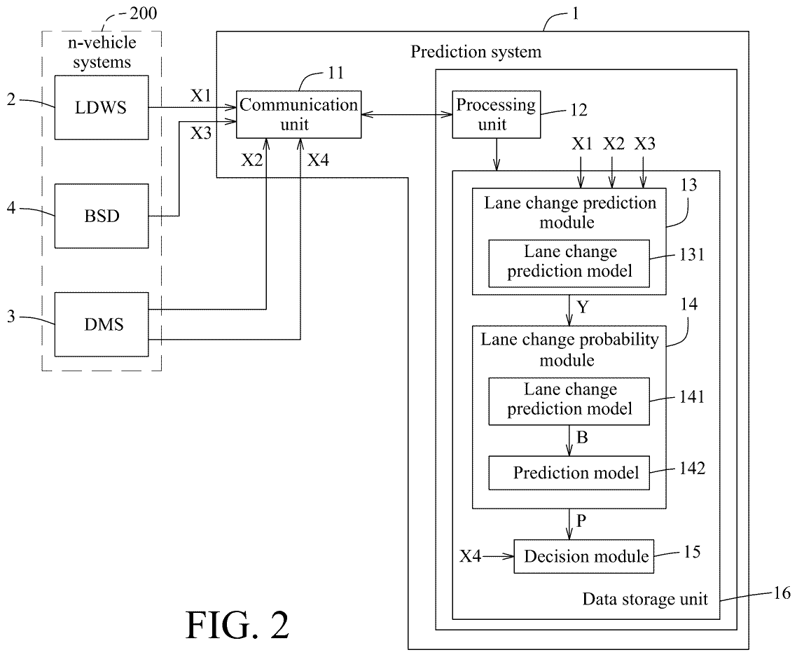

FIG. 2 is a block diagram illustrating a prediction system 1 for implementing vehicle lane change prediction according to one embodiment of the disclosure. In the embodiment of FIG. 2, the prediction system 1 is configured to be in communication with one or more in-vehicle systems 200 that are installed in a vehicle (not depicted in the drawings), and includes a communication unit 11, a processing unit 12 and a data storage unit 16. In some embodiments, the prediction system 1 may be implemented by a computer (e.g., a notebook computer), but is not limited thereto. In some embodiments, the prediction system 1 may be integrated into or disposed in a vehicle digital video recorder.

The processing unit 12 may be embodied using one or more of a central processing unit (CPU), a microprocessor, a microcontroller, a single core processor, a multi-core processor, a dual-core mobile processor, a digital signal processor (DSP), a field-programmable gate array (FPGA), an application specific integrated circuit (ASIC), a system on chip (SoC), a radio-frequency integrated circuit (RFIC), etc.

The communication unit 11 is electrically connected to the processing unit 12, and may include one or more of an RFIC, a short-range wireless communication module supporting a short-range wireless communication network using a wireless technology of Bluetooth® and/or Wi-Fi, etc., and a mobile communication module supporting telecommunication using Long-Term Evolution (LTE), the third generation (3G), the fourth generation (4G) or the fifth generation (5G) of wireless mobile telecommunications technology, or the like. In use, the system 1 is able to communicate with the in-vehicle systems 200 via the communication unit 11. In some embodiments, the communication unit 11 is a physical connector that allows wired connection with the in-vehicle systems 200.

The data storage unit 16 is connected to the processing unit 12, and may be embodied using, for example, random access memory (RAM), read only memory (ROM), programmable ROM (PROM), firmware, flash memory, or other suitable non-transitory storage media. The data storage unit 16 stores a software application and a database therein. The software application includes instructions that, when executed by the processing unit 12, cause the processing unit 12 to implement the operations as described below.

In the embodiment of FIG. 2, the in-vehicle systems 200 include a lane departure warning system (LDWS) 2, a driver monitoring system (DMS) 3, and a blind spot detection (BSD) system 4.

The LDWS 2 includes a front camera that captures images in front of the vehicle, and is configured to process the images in front of the vehicle to determine whether the vehicle is drifting out of a lane unintendedly. In some embodiments, the LDWS 2 may continuously calculate a lateral offset value of the vehicle based on the images in front of the vehicle while the vehicle is in a driving state, and periodically transmit an offset signal (X1) indicating the lateral offset value of the vehicle to the prediction system 1. In some embodiments, the LDWS 2 may determine that the vehicle is in the driving state in a case where a velocity of the vehicle is greater than a predetermined threshold (e.g., 30 km/h). In use, the LDWS 2 may generate and output an alert (e.g., an audible and/or a visual alert) to notify a driver of the vehicle in a case where it is determined that the vehicle is drifting out of a lane unintendedly. In some embodiments, the LDWS 2 may further calculate a front distance between the vehicle and an front object (e.g., another vehicle in front of the vehicle) using the images in front of the vehicle, and in a case where the front distance is smaller than a predetermined threshold while the vehicle is in the driving state, the LDWS 2 may generate and output an alert to notify the driver.

It is noted that since the operations of the LDWS 2 are readily known in the related art, the details thereof are omitted herein for the sake of brevity.

The DMS 3 includes an in-vehicle camera that captures images of the driver of the vehicle, and is configured to process the images of the driver to determine whether the driver is in a distracted state (e.g., he/she is turning head, he/she is dozing off, etc.), and to output an alert (e.g., an audible and/or a visual alert) to notify the driver in a case where the driver is determined to be in the distracted state. In this embodiment, the DMS 3 processes, by using techniques of image recognition, the images of the driver to determine a turning angle of a head of the driver with respect to a front direction of the vehicle and a facial condition of the driver, and determines whether the driver is in the distracted state based on the turning angle and the facial condition. It is noted that since the operations of the DMS 3 are readily known in the related art, the details thereof are omitted herein for the sake of brevity.

In some embodiments, the DMS 3 may continuously calculate the turning angle of the head of the driver based on the images of the driver while the vehicle is in the driving state, and periodically transmit a turning angle signal (X2) indicating the turning angle to the prediction system 1. In some embodiments, the offset signal (X1) and the turning angle signal (X2) constitute a driving state dataset.

The BSD system 4 includes multiple outside cameras that capture images around the vehicle, and is configured to determine, based on the images around the vehicle, one or more blind spots which the driver is unable to see. Then, the BSD system 4 is further configured to determine whether an object (e.g., another vehicle) is within one of the blind spots, and, in a case where it is determined that an object is located within one of the blind spots, to generate a blind spot object signal (X3) indicating a location of the object within the one of the blind spots (and therefore, a distance of the object within the one of the blind spots and the vehicle). In some embodiments, the BSD system 4 may continuously detect the object in the blind spots, and periodically transmit the blind spot object signal (X3) to the prediction system 1.

It is noted that since the operations of the BSD system 4 are readily known in the related art, the details thereof are omitted herein for the sake of brevity. In some embodiments, the driving state dataset further includes the blind spot object signal (X3).

It is noted that in some embodiments, the BSD system 4 may be omitted. That is to say, the in-vehicle systems 200 may only include the LDWS 2 and the DMS 3.

The data storage unit 16 stores a number of software modules that may be executed by the processing unit 12 so as to implement the functions as described below. In the embodiment of FIG. 2, the software modules includes a lane change prediction module 13, a lane change probability module 14, and a decision module 15.

The lane change prediction module 13 includes a lane change prediction model 131. In some embodiments, the lane change prediction model 131 may be embodied using a recurrent neural network (RNN) or other suitable neural networks that are pre-trained using a first driving state dataset and a second driving state dataset.

The lane change probability module 14 includes a feature conversion unit 141 and a prediction model 142. The feature conversion unit 141 may be embodied using a convolutional neural network (CNN), a Bayesian Neural Network (BNN), etc. The predication model 142 may be embodied using a Bayesian classifier or other suitable neural networks.

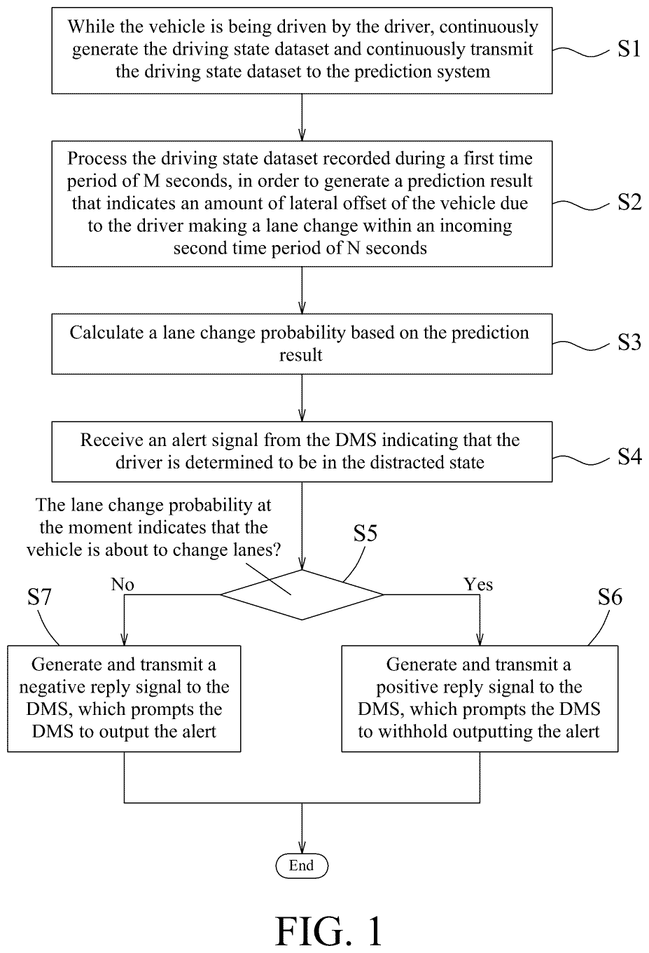

FIG. 1 is a flow chart illustrating steps of a method for implementing vehicle lane change prediction according to one embodiment of the disclosure. In some embodiments, the method may be implemented using the prediction system 1 shown in FIG. 2.

In step S1, while the vehicle is being driven by the driver, the in-vehicle systems 200 continuously generate the driving state dataset that includes the offset signal (X1), the turning angle signal (X2) and the blind spot object signal (X3), and continuously transmits the driving state dataset to the prediction system 1. The driving state dataset is then transmitted to the lane change prediction module 13 for processing.

To determine whether the driver intends to turn the vehicle, the prediction system 1 may process the images of the driver to determine whether the driver has turned his/her head accordingly. In order to address different behavior patterns of different drivers, in some embodiments of the disclosure, the determination of whether the driver intends to turn the vehicle may be done using standards specifically set for the driver. For example, some drivers may prefer to change lanes in a relatively slow and smooth fashion, while others may change lanes in a fast and abrupt fashion. In another example, prior to changing lanes, some drivers may turn their heads to see a corresponding one of the rearview mirrors, while some drivers may turn their heads with a relatively large range of motion to further see a target lane. As such, by processing the images of the driver being in the driving state, specific behaviors of the driver and corresponding movements of the vehicle may be determined.

Then, in step S2, the lane change prediction module 13 processes the driving state dataset recorded during a first time period of M seconds, in order to generate a prediction result that indicates an amount of lateral offset of the vehicle due to the driver making a lane change within an incoming second time period of N seconds. In some embodiments, the number M may be 10, and the number N may be 5. Generally, the number M may be selected to be not less than 5, and the number N may be selected to be a time period not less than 2 seconds. By setting the first time period to a relatively longer time period, more of the driver's actions and the situations around the vehicle may be processed so as to obtain a more accurate prediction result.

Specifically, in some embodiments, the lane change prediction model 131 may be structured to include six gated recurrent unit (GRU) layers, and a dense layer that is connected to the GRU layers and that serves as a layer outputting the prediction result. Each of the GRU layers includes 64 units, and the dense layer includes 5 units.

It is noted that the GRU layers are employed for some of its specific characteristics. For example, the GRU layers are suitable for capturing long-term dependency and short-term dependency within time-sequential data in a balanced manner while avoiding being too reliant on one single data point, and therefore is suitable for processing the driving state dataset that is recorded over time. The number of units of the dense layer may be selected based on the second time period.

In use, prior to implanting the method, the in-vehicle systems 200 may record a number of images of the driver while the vehicle is in the driving state. The images, the offset signal (X1), the turning angle signal (X2) and the blind spot object signal (X3) may be calculated over time and recorded as the data used for training the lane change prediction model 131.

The first driving state dataset used for training the lane change prediction model 131 may include a plurality of subsets (e.g., 100 subsets) of first driving state data that indicate the driver is found to be in a distracted state (he/she is turning his/her head, indicated by the turning angle signal (X2)) and is not attempting to change lanes (the vehicle is not being turned, indicated by the offset signal (X1)). Each of the subsets of first driving state data includes data recorded by the in-vehicle systems 200 within a predetermined time period (e.g., M seconds). In some embodiments, each of the subsets of first driving state data further includes the blind spot object signal (X3). As such, the offset signal (X1) and the turning angle signal (X2) may be considered as main factors, and the blind spot object signal (X3) may be considered as a secondary factor for implementing the determination. In some embodiments, a relative velocity and a relative location of the object in one of the blind spots with respect to the vehicle may be also calculated.

In some embodiments, data related to some preset rules may be incorporated into the training of the lane change prediction model 131. For example, an observation action of the driver turning his/her head heavily towards a specific direction (e.g., looking at one of the blind spots) may be determined as the driver trying to observe the vicinity of the specific direction to determine whether an object is present and/or what kind of object is present (e.g., a regular vehicle such as a sedan or a larger vehicle such as a truck), and the driver may do something (e.g., trying to overtake a regular vehicle, trying to slow down to make way for the larger vehicle, etc.) after the observation action. The above behaviors of the driver under the preset rules may be recorded and incorporated into the training of the lane change prediction model 131 in an evidence-based manner.

The second driving state dataset used for training the lane change prediction model 131 may include a plurality of subsets (e.g., 100 subsets) of second driving state data that indicate the driver is attempting to change lanes (e.g., the vehicle is being turned, indicated by the offset signal (X1), after the driver has turned his/her head, indicated by the turning angle signal (X2)). Each of the subsets of second driving state data includes data recorded by the in-vehicle systems 200 within the predetermined time period (M seconds). In some embodiments, each of the subsets of second driving state data further includes the blind spot object signal (X3). As such, the offset signal (X1) and the turning angle signal (X2) may be considered as main factors, and the blind spot object signal (X3) may be considered as a secondary factor for implementing the determination. In some embodiments, a relative velocity and a relative location of the object in one of the blind spots to the vehicle may also be calculated.

In some embodiments, additional data recorded by the in-vehicle systems 200 may be incorporated into the training of the lane change prediction model 131. For example, the front distance between the vehicle and the front object calculated by the LDWS 2 may be used in conjunction with the actions of the driver as a secondary factor. Specifically, it is known that different drivers may exhibit different behaviors such as a preferred front distance between the vehicle and a front vehicle. Some drivers may prefer to keep a longer front distance from the front object, and as such, when the front distance decreases, they do not wish to have to step on a brake frequently and tend to aggressively observe nearby lanes to find an opening for changing lanes. Alternatively, some drivers may be able to tolerate having a shorter front distance with the front vehicle. The above behaviors of the driver under the preset rules may be recorded for specific drivers in longer time periods, and then incorporated into the driving state datasets used for training of the lane change prediction model 131 that reflects the behavioral patterns of the driver in an evidence-based manner, and as such, using a combination of the aforementioned main factors and the secondary factor, the lane change prediction model 131 may be able to more accurately distinguish whether the driver is intently turning his/her head in an attempt to change lane or is turning his/her head while being distracted.

In some embodiments, the lane change prediction module 13 may include a plurality of customized lane change prediction models that are pre-trained using different datasets associated with different drivers. For example, for a plurality of people who have driven the same vehicle, different datasets may be recorded, and a corresponding one of customized lane change prediction models may be generated and stored for each person. In such cases, every time the vehicle is started, the prediction system 1 may determine who the driver is, and load the corresponding one of the lane change prediction models 131. In some embodiments, the customized lane change prediction models associated respectively with different drivers are trained and stored in a server (e.g., a cloud server) in advance. In response to receipt of a piece of identification data that is transmitted from the in-vehicle systems 200 in a target vehicle and that is related to a target one of the drivers (hereinafter also referred to as the target driver), the server would identify the target driver based on the identification data, select one of the customized lane change prediction models stored therein that corresponds to the target driver (hereinafter also referred to as the target model), and send the target model to the prediction system 1 for the target vehicle to replace the lane change prediction model 131 of the lane change prediction module 13 in the target vehicle with the target model. In some embodiments, the behavioral patterns of different drivers may also be incorporated into the corresponding lane change prediction models.

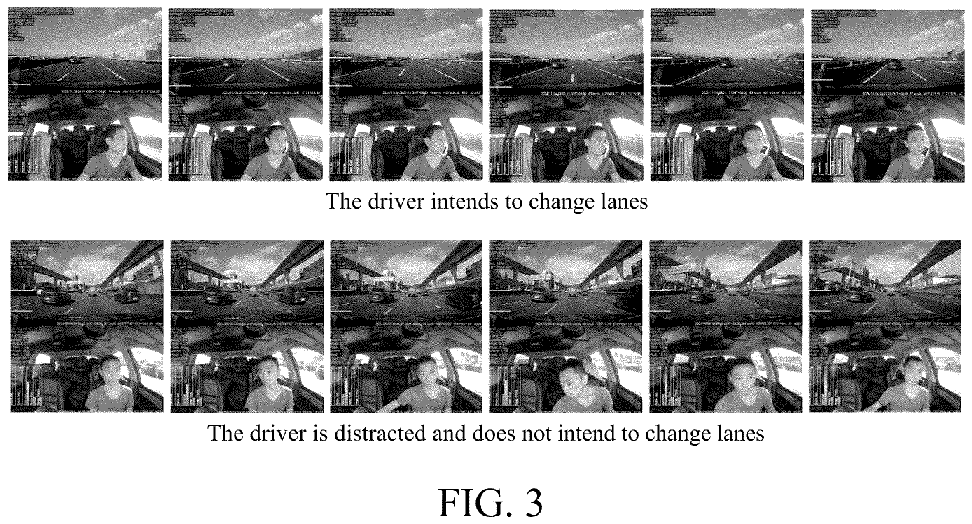

FIG. 3 illustrates a first set of successive images, in which the driver intends to change lanes, and a second set of successive images, in which the driver is distracted and does not intend to change lanes. The first set of images illustrates that the driver turns his head to the left before turning the vehicle to change lanes to the left, indicating that he turned his head to check whether it is safe to change lanes. The second set of images illustrates that the driver checks the right side and then the left side over time and is generally looking down (i.e., indicating he may be looking for something) while the vehicle is passing over a vehicle on a right part of the images, without actually turning the vehicle and does not check the rearview mirror in the entire duration. As such, the first set of images may be categorized into the second driving state dataset indicating the attempt to change lanes, and the second set of images may be categorized into the first driving state dataset indicating the driver in a distracted state. The training of the lane change prediction model 131 aims to enable the lane change prediction module 13 to correctly predict whether the driver intends to change lanes or is simply distracted. It is noted that operations of the lane change prediction model 131 thus trained may be more accurate in predicting whether the driver intends to change lanes or is simply distracted. Since in both of the first set of images and the second set of images, the driver turned his head at similar angles, the conventional manners are not able to tell the difference therebetween.

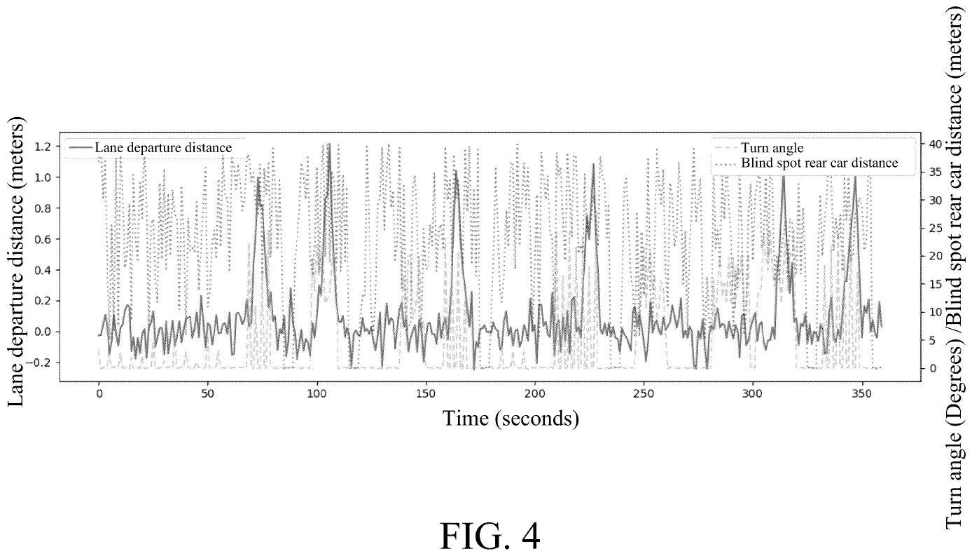

FIG. 4 is a graph illustrating a test dataset that includes the offset signal (X1), the turning angle signal (X2) and the blind spot object signal (X3) over a time period of about 350 seconds. In the time period, a number of actions and the movement of the vehicle are included. For example, the test dataset includes the action of the driver turning his/her head before turning the vehicle, which may be categorized into the second driving state dataset, and the action of the driver turning his/her head without turning the vehicle, which may be categorized into the first driving state dataset.

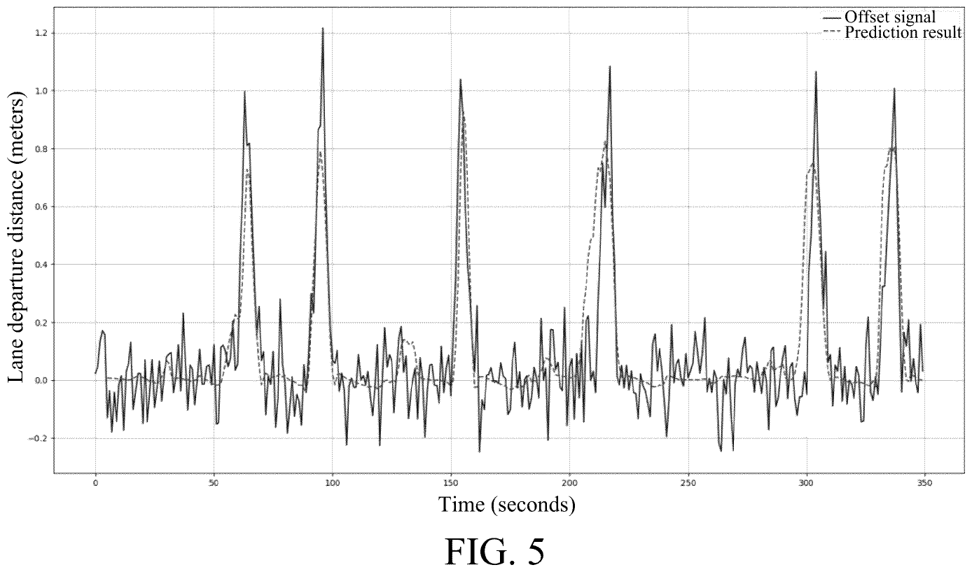

FIG. 5 is a graph illustrating the offset signal (X1) of the test dataset and the prediction result (Y) generated by the lane change prediction model 131 over time. Based on the graph of FIG. 5, it may be concluded that an action of the driver suddenly turning the vehicle may be predicted by the lane change prediction model 131 within about 1 to 3 seconds.

In step S3, the lane change probability module 14 calculates a lane change probability based on the prediction result (Y).

Specifically, in this embodiment, the prediction result (Y) may be in the form of a matrix (Y_i)=[y_1, y_2, . . . , y_5], where y_i represents an estimated probability of a lane change in an incoming i^{th} second, and i is equal to any one of 1 to 5. In particular, the prediction result (Y) is calculated by using a sliding window technique where a sliding window having a window size of five seconds is used.

The feature conversion unit 141 processes the prediction result (Y) to obtain feature value data (B) for the prediction model 142. Specifically, the feature conversion unit 141 transforms the prediction result (Y) into the feature value data (B). The resulting feature value data (B) may be in the form of a matrix (B_ij)=[b_i₁, b_i₂], where b_i₁=Var(Y_i), b_i₂=max(Y_i), i=1-5, and j=1-2.

In use, the prediction model 142 may be pre-trained using a plurality of feature value datasets each being associated with a specific probability, in order to obtain a prior probability for the prediction model 142. As a result, when the feature value data (B) is inputted into the prediction model 142, the prediction model 142 outputs a conditional probability of P_i(C|B), where i=1-5, to serve as the lane change probability.

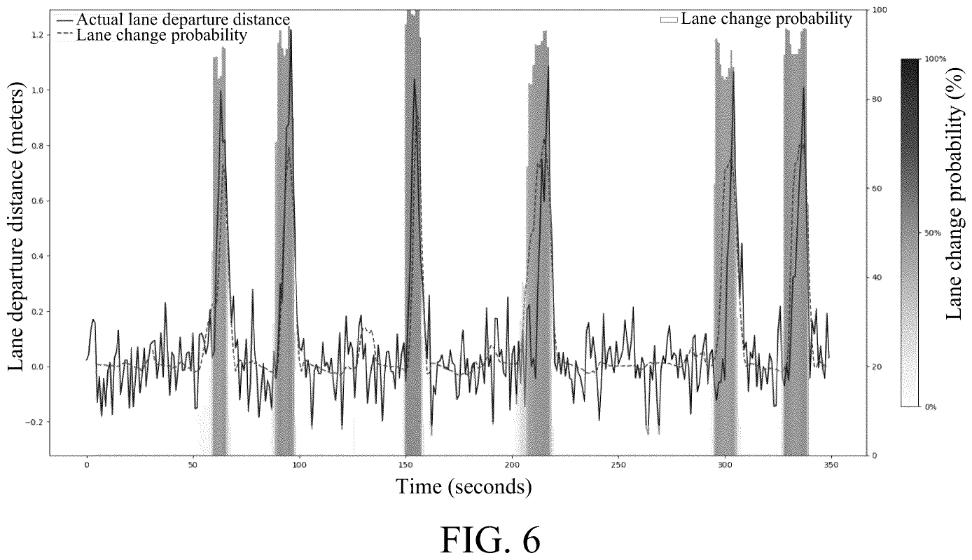

FIG. 6 is a graph illustrating the offset signal (X1) of the test dataset, the prediction result (Y) generated by the lane change prediction model 131 and the lane change probability generated by the lane change probability module 14 over time. It is worthy of note that in FIG. 6, a shaded bar represents a degree of confidence in determining by the lane change prediction model 131 that the vehicle is going to make a lane change, and the degree of confidence is positively correlated to the lane change probability (which ranges from 0% to 100%). The higher/darker the shaded bar, the greater the degree of confidence, and the more probably the vehicle is going to make a lane change rather than to stay in one lane. The lower/lighter the shaded bar, the smaller the degree of confidence, and the more probably the vehicle is going to stay in one lane rather than to make a lane change. Based on the graph of FIG. 6, it may be concluded that the action of the driver suddenly turning the vehicle may be predicted by the lane change prediction model 131 within about 1 to 3 seconds.

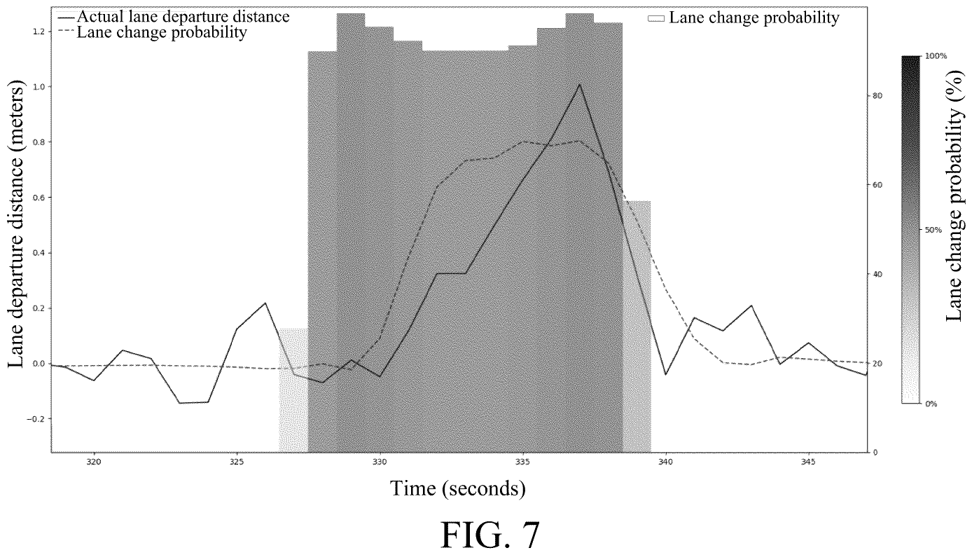

FIG. 7 is a partially enlarged view of FIG. 6. It can be seen that at the time instance of about the 327^{th} to 328^{th} second, the lane change probability generated by the lane change probability module 14 has spiked, and the offset signal (X1) indicates that the vehicle starts being turned at about the 331^{th} second, which is about 1 to 3 seconds behind. That is to say, by using the lane change prediction model 131 that is customized to the behavioral pattern of the driver, the system 1 is able to more accurately predict when the vehicle is about to change lanes about 1 to 3 seconds in advance. It is worthy of note that each of the LDWS 2 and the DMS 3 generally takes a detection time period to make a determination as to whether or not the driver is in the distracted state, and the detection time period is longer than a time period when the lane change prediction model 131 is used to make such determination by 1 to 3 seconds.

In some embodiments, the decision module 15 is connected to the lane change probability module 14 to receive the lane change probability therefrom, and is connected to the DMS 3. In a case where the DMS 3 determines that the driver is in the distracted state and generates an alert to notify the driver, in step S4, the DMS 3 may generate and transmit an alert signal (X4) to the decision module 15, indicating that the driver is determined to be in the distracted state.

In response to receipt of the alert signal (X4), in step S5, the decision module 15 determines whether the lane change probability at the moment indicates that the vehicle is about to change lanes. For example, the decision module 15 may determine whether the largest value of the lane change probability in the next 1-3 seconds is greater than a predetermined threshold (e.g., 0.7), wherein the lane change probability being larger than the predetermined threshold indicates that the vehicle is about to change lanes. In a case where it is determined that the lane change probability at the moment indicates that the vehicle is about to change lanes, the flow proceeds to step S6, in which the decision module 15 generates and transmits a positive reply signal to the DMS 3, which prompts the DMS 3 to withhold outputting the alert since it is determined that the vehicle is about to change lanes, and therefore the driver turning his/her head may not indicate he/she is distracted. In response, the DMS 3 is prevented from outputting the alert that may be incorrect and unnecessary. In this manner, the method can effective reduce the “false alert” that may be outputted incorrectly, solving a potential drawback presented by the conventional DMS.

Alternatively, in a case where the lane change probability at the moment indicates that the vehicle is not about to change lanes, the flow proceeds to step S7, in which the decision module 15 generates and transmits a negative reply signal to the DMS 3, which prompts the DMS 3 to output the alert since it is determined that the vehicle is not about to change lanes, and therefore the driver turning his/her head may indeed indicate that he/she is distracted. In response, the DMS 3 outputs the alert. By using the above manner, the DMS 3 may be controlled to more accurately output the alert for the driver.

To sum up, embodiments of the disclosure provide a method and a system for implementing vehicle lane change prediction. In the method, a lane change prediction model is trained using the images of a driver driving a vehicle and various factors such as the offset signal indicating the lateral offset value of the vehicle at the same time period when the driver is driving the vehicle, which illustrates the behavioral pattern of the driver in different situations. Then, while the vehicle is in a driving state, the method is implemented to use the lane change prediction model to generate a prediction result based on the images of the driver and the offset signal received from an in-vehicle electronic device installed in the vehicle. Then, based on the prediction result, a lane change probability based on the prediction result is calculated to determine whether the vehicle is about to change lanes. Since the lane change probability calculated in this manner is more accurate than that calculated in conventional methods, the lane change probability may be utilized to determine whether a DMS module of the in-vehicle electronic device is generating an alert that may be unnecessary. In this manner, the in-vehicle system may be prevented from generating an alert that may be unnecessary, and the alerts that are outputted may be in turn more impactful to the driver.

It is noted that the method may be particularly useful in the cases where the in-vehicle system is not connected to a set of turn lights or a signal lever of the vehicle. In addition, in cases where the prediction system is connected to the in-vehicle systems of a fleet of a large number of vehicles that are being managed, the images of the driver related to false alarms need not be transmitted and stored by the prediction system, and the cost of network traffic may be reduced.

According to one embodiment of the disclosure, the prediction system 1 may be integrated with the in-vehicle system 200.

According to one embodiment of the disclosure, there is a non-transitory computer readable storage medium which stores instructions that, when executed by a processor of a system connected to an in-vehicle electronic device, cause the processor to implement the steps of a method as shown in FIG. 1.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method for implementing vehicle lane change prediction for a vehicle, the method being implemented using a system that is connected to an in-vehicle electronic device installed in the vehicle, the system including a lane change prediction module and a lane change probability module, the method comprising the steps of:
training a lane change prediction model using a first driving state dataset and a second driving state dataset, wherein the first driving state dataset includes a plurality of subsets of first driving state data that indicate the driver is found to be in a distracted state and is not attempting to change lanes, and the second driving state dataset includes a plurality of subsets of second driving state data that indicate the driver is attempting to change lanes;
a) while the vehicle is being driven by a driver, continuously receiving a driving state dataset from the in-vehicle electronic device;
b) processing, by the lane change prediction module, the driving state dataset recorded associated with a first time period, in order to generate a prediction result that indicates an amount of lateral offset of the vehicle due to the driver making a lane change within an incoming second time period; and
c) calculating, by the lane change probability module, a lane change probability based on the prediction result.

2. The method as claimed in claim 1, the in-vehicle system including a lane departure warning system (LDWS) that is configured to generate an offset signal indicating a lateral offset value of the vehicle and a driver monitoring system (DMS) that is configured to generate a turning angle signal indicating a turning angle of a head of the driver with respect to a front direction of the vehicle, wherein the driving state dataset includes the offset signal and the turning angle signal.

3. The method as claimed in claim 2, the in-vehicle system further including a blind spot detection (BSD) system that identifies a blind spot associated with the vehicle, and that is configured to generate a blind spot object signal indicating a location of an object within the blind spot, wherein the driving state dataset further includes the blind spot object signal.

4. The method as claimed in claim 3, wherein each of the plurality of subsets of first driving state data includes the offset signal, the turning angle signal and the blind spot object signal, and each of the plurality of subsets of second driving state data includes the offset signal, the turning angle signal and the blind spot object signal.

5. The method as claimed in claim 1, the in-vehicle system including a driver monitoring system (DMS) that is configured to generate a turning angle signal indicating a turning angle of a head of the driver with respect to a front direction of the vehicle, the prediction system further including a decision module that is connected to the lane change probability module to receive the lane change probability therefrom, and that is connected to the DMS, the method further comprising the steps of, after step c):
receiving, by the decision module, an alert signal from the DMS indicating that the driver is determined to be in the distracted state;
determining, based on the lane change probability calculated by the lane change probability module, whether the lane change probability at present indicates that the vehicle is about to change lanes; and
in a case where the lane change probability at present indicates that the vehicle is about to change lanes, generating and transmitting a positive reply signal to the DMS, which prompts the DMS to withhold outputting an alert.

6. The method as claimed in claim 5, wherein:
determining whether the lane change probability at present indicates that the vehicle is about to change lanes is to determine whether the lane change probability is greater than a predetermined threshold; and
the lane change probability being greater than the predetermined threshold indicates that the vehicle is about to change lanes.

7. The method as claimed in claim 1, the lane change probability module including a feature conversion unit and a prediction model, wherein step c) includes:
processing, by the feature conversion unit, the prediction result to obtain feature value data for the prediction model; and
in response to receiving the feature value data, outputting, by the prediction model, a conditional probability to serve as the lane change probability.

8. The method as claimed in claim 7, further comprising, prior to step c), training the prediction model using a plurality of feature value datasets, each of the plurality of feature value datasets being associated with a specific probability.

9. A prediction system for implementing vehicle lane change prediction for a vehicle, the prediction system being connected to an in-vehicle electronic device installed in the vehicle and comprising a lane change prediction module and a lane change probability module, wherein:
the lane change prediction module includes a lane change prediction model pre-trained using a first driving state dataset and a second driving state dataset, wherein the first driving state dataset includes a plurality of subsets of first driving state data that indicate the driver is found to be in a distracted state and is not attempting to change lanes, and the second driving state dataset includes a plurality of subsets of second driving state data that indicate the driver is attempting to change lanes;
while the vehicle is being driven by a driver, the prediction system continuously receives a driving state dataset from the in-vehicle electronic device;
in response to receipt of the driving state dataset, the lane change prediction module processes the driving state dataset recorded associated with a first time period, and to generate a prediction result that indicates an amount of lateral offset of the vehicle due to the driver making a lane change within an incoming second time period; and
the lane change probability module calculates a lane change probability based on the prediction result.

10. The prediction system as claimed in claim 9, the in-vehicle system including a lane departure warning system (LDWS) that is configured to generate an offset signal indicating a lateral offset value of the vehicle and a driver monitoring system (DMS) that is configured to generate a turning angle signal indicating a turning angle of a head of the driver with respect to a front direction of the vehicle, wherein the driving state dataset includes the offset signal and the turning angle signal.

11. The prediction system as claimed in claim 10, the in-vehicle system further including a blind spot detection (BSD) system that identifies a blind spot associated with the vehicle, and that is configured to generate a blind spot object signal indicating a location of an object within the blind spot, wherein the driving state dataset further includes the blind spot object signal.

12. The prediction system as claimed in claim 11, wherein each of the plurality of subsets of first driving state data includes the offset signal, the turning angle signal and the blind spot object signal, and each of the plurality of subsets of second driving state data includes the offset signal, the turning angle signal and the blind spot object signal.

13. The prediction system as claimed in claim 9, the in-vehicle system including a driver monitoring system (DMS) that is configured to generate a turning angle signal indicating a turning angle of a head of the driver with respect to a front direction of the vehicle, the prediction system further comprising a decision module that is connected to the lane change probability module to receive the lane change probability therefrom, and that is connected to the DMS, wherein, after the calculation of the lane change probability:
the decision module receives an alert signal from the DMS indicating that the driver is determined to be in the distracted state, and determines, based on the lane change probability calculated by the lane change probability module, whether the lane change probability at present indicates that the vehicle is about to change lanes; and
in a case where the lane change probability at present indicates that the vehicle is about to change lanes, the decision module generates and transmits a positive reply signal to the DMS, which prompts the DMS to withhold outputting an alert.

14. The prediction system as claimed in claim 13, wherein:
the decision module determines whether the lane change probability at present indicates that the vehicle is about to change lanes by determining whether the lane change probability is greater than a predetermined threshold; and
the lane change probability being greater than the predetermined threshold indicates that the vehicle is about to change lanes.

15. The prediction system as claimed in claim 9, wherein the lane change probability module including a feature conversion unit and a prediction model, wherein the lane change probability module calculates a lane change probability by:
processing, by the feature conversion unit, the prediction result to obtain feature value data for the prediction model; and
in response to receiving the feature value data, outputting, by the prediction model, a conditional probability to serve as the lane change probability.

16. The prediction system as claimed in claim 15, wherein the prediction model us trained using a plurality of feature value datasets, each of the plurality of feature value datasets being associated with a specific probability.

17. A non-transitory computer readable storage medium which stores instructions that, when executed by a processor of a system connected to an in-vehicle electronic device, cause the processor to implement the steps of the method as claimed in claim 1.
